(19) United States
(12) Patent Application Publication
(10) Pub. No.: US 2015/0006378 A1
(43) Pub. Date: Jan. 1, 2015

(54) USER DEVICES, SYSTEMS AND METHODS FOR USE IN TRANSACTIONS

(71) Applicant: MasterCard International Incorporated, Purchase, NY (US)

(72) Inventor: Simon Blythe, Cambridgeshire (GB)

(21) Appl. No.: 14/316,474

(22) Filed: Jun. 26, 2014

(30) Foreign Application Priority Data
Jun. 27, 2013 (GB) 1311575.3

(51) Int. Cl. G06Q 20/32; G06K 19/073; G06Q 20/34; G06K 19/07

(52) U.S. Cl. CPC G06Q 20/3278; G06K 19/0716; G06K 19/07345; G06Q 20/352
USPC 705/41; 235/380

(57) ABSTRACT

A user device for use in a transaction is provided. The user device includes a communicator configured to allow communication, between the user device and a reader device, for executing the transaction, a sensor configured to detect a movement of the user device, and a trigger element configured to, on detection of the movement of the user device, initiate a process for the transaction.

### CROSS REFERENCE TO RELATED APPLICATIONS

This application claims the benefit of GB Patent Application No. 1311575.3 filed Jun. 27, 2013, which is hereby incorporated by reference in its entirety.

### BACKGROUND OF THE DISCLOSURE

The field of the disclosure relates generally to user devices, systems and methods for use in transactions, for example near-field communication or proximity transactions, and, more particularly, to initiation of processes for such transactions using unconventional means.

In at least some known cases, user devices (e.g., user computing devices, transaction cards, etc.) are used to perform various types of electronic transactions. For example, user transaction cards can be used for payment or account transactions at ATMs, or at merchant points of interactions. These may use magnetic stripe or chip and PIN interactions. Proximity transactions, such as near-field communication (NFC), contactless, or local/wireless transactions are also well known. Mobile telecommunication devices can be used for similar transactions. Identification transactions can also be performed using such technologies.

Transactions using, in addition, systems of verification or authentication are also known; these attempt to ensure that the holder of a card or other transaction device is the legitimate user. For example, the chip and PIN system requires a user to enter a PIN number or password which is checked against a record on a smart card chip on their transaction card. Transaction cards commonly have a user's signature affixed, which is matched with a user signature at the time of the transaction. Online transactions require passwords and other verification. Mobile devices record user keys or PINs which must be entered by a user before a transaction can be completed, for example on a mobile banking application.

However, such systems can be vulnerable, as it is possible for the password, key or PIN to become known by a third party that is not the authorized user of the financial transaction device or account holder. If this occurs, the third party can fraudulently use the password to undertake a transaction.

Transaction devices for proximity transactions, such as ID cards or payment cards, are usually “always on”, in that the method of proximity or near-field communication is constantly enabled so that the device can interact with a reader as soon as one is present close by. This may mean that if stolen, such transaction devices may be easier to be used fraudulently. Furthermore, such devices may be more vulnerable to eavesdropping, relay or interception attacks. The reliability of such devices may also be hampered if the communication means is constantly enabled. These disadvantages may also apply to mobile devices using similar technology.

In addition, low value contactless or NFC payment transactions typically do not require an authentication step, such as the entry of a PIN number; there are hence concerns over the possibilities for fraud or misuse of the transaction device in such systems.

U.S. Patent Application Publication No. 2008/0217413 discloses an ID card having an RFID integrated circuit (IC) and a pressure-sensitive switch to activate the card, the switch coupled to the RFID IC via an electrode structure.

Some transaction devices, such as transaction cards, may be somewhat limited in access capabilities; they usually perform a single or small set of functions, with little ability for the user to change features of the capabilities or the transaction to be performed.

### BRIEF DESCRIPTION OF THE DISCLOSURE

In one embodiment of a first aspect, a user device for use in a transaction is provided. The user device includes a communicator configured to allow communication, between the user device and a reader device, for executing the transaction, a sensor for detecting a movement of the user device, and a trigger element configured to, on detection of the movement of the user device, initiate a process for the transaction.

This provides a simple, reliable and potentially highly secure means of managing the transactional capabilities of the user device.

The transaction may be a proximity transaction.

Suitably, the trigger element is configured to, on the detection of the movement, activate, or unlock, a component of the user device to allow the transaction to proceed. Similarly, the trigger element may be configured to deactivate or lock the component, preventing the transaction, or continuation of the transaction. The activation or unlocking may turn the user device on, or may power those parts of the device not already activated. For example, the sensor may remain on continuously, with all other parts of the device powered down until activation. In one embodiment, the trigger element is configured to, on the detection of the movement, activate the communicator to allow the transaction to proceed.

These features provide a simple means of preventing access to the user device's transactional capabilities, in certain circumstances. They also provide greater interactivity for the user with the device.

Suitably, the trigger element is configured to, on the detection of the movement, trigger the process during the transaction.

The trigger element may be a processor.

In one embodiment, a user device for use in a transaction is provided. The user device includes a communicator configured to allow communication, between the user device and a reader device, for executing the transaction, a sensor for detecting a movement of the user device, and a processor configured to, on detection of the movement of the user device, initiate a decryption process for the transaction. The processor may similarly also be configured to provide user authentication information for the transaction. Suitably, the processor is configured to, on the detection of the movement, provide information from the movement sensor to the communicator for communication to the reader device.

The device is thus able to provide security features for a transaction which would otherwise not use or be able to use them, or additional security features for transactions which may require them.

Suitably, the processor is configured to, on the detection of the movement, store information from the movement sensor. The processor may process for storage a plurality of instances or sets of such information, for example to record iteratively a particular movement. The processor may be configured to learn a movement of a user of the device, for example by storing movement information during similar transactions. In some embodiments, the processor is configured to, on the detection of the movement, compare information from the movement sensor with stored movement information. The processor may be configured to establish a match between current movement information and stored movement information.

Such features may provide a particularly secure means of controlling the transactions the device may be used for.

The trigger element may be configured to initiate the process on detection of a prescribed movement of the user device. In some embodiments, the prescribed movement may have been stored on the device, or programmed into the processor. Alternatively, the prescribed movement may be an iterative composite of previous movements, for example being learned by the steps noted above.

This provides a further and potentially more complex, and therefore secure, means for preventing access or capabilities unless authorized by the user. Storage and iteration may allow for the prescribed movement to be generated by use of the device itself.

The sensor may be a motion sensor, such as an accelerometer. Suitably, the accelerometer may be linked to a processor on the device, or may be incorporated in a chip on the device. For example, a smart card chip may have the accelerometer bonded to the chip, or linked to the chip, or connected on the same substrate.

In one embodiment, the trigger element is mechanical. For example, the trigger may be actuable in one or a sequence of movements representing an unlocking motion, which mechanically triggers an unlocking of a component of the device. This may provide advantages of ease of use and reliability.

In one embodiment, the user device is a transaction card comprising an integrated circuit chip. In another embodiment, the user device is a mobile telecommunication device.

The user device may further include an indicator, the indicator configured to be activated on one or both of the detection of the movement by the sensor, and the initiation of the process for the transaction. The indicator may be visual, auditory or of another sense type.

The communicator of the user device may use radio frequency communication. The communicator may be configured to interact with an electromagnetic field of the reader device. The communicator may be passive, so that a signal from the reader device is received, and a response is transmitted by the user device. These features may be accomplished by the user device including one or more of a receiver, transmitter, transceiver, transponder and antenna.

In one embodiment of a second aspect, a system for executing a transaction is provided. The system includes a user device, a reader device, wherein each of the user device and the reader device includes a communicator configured to allow communication, between the user device and a reader device, for executing the transaction, a sensor for detecting a movement of the user device, and a trigger element configured to, on detection of the movement of the user device, initiate a process for the transaction.

Suitably, either the user device or the reader device includes the sensor. In one embodiment, the system further includes an indicator, the indicator configured to be activated on one or both of the detection of the movement by the sensor, and the initiation of the process for the transaction. The user device may include the indicator, where the user device includes the sensor, or the reader device may include the indicator where the reader has the sensor, or the indicator may be on that of the two which does not include the sensor.

In one embodiment of a third aspect, a method of initiating, for a user device, a process for a transaction is provided. The user device includes a communicator configured to allow communication, between the user device and a reader device, for executing the transaction. The method includes detecting a movement of the user device, and on detection of the movement of the user device, initiating a process for the transaction.

The step of detecting may include detecting a prescribed movement of the user device, and the step of initiating includes initiating the process on detection of the prescribed movement.

Suitably, the transaction is a proximity transaction.

In one embodiment, the step of initiating the process includes activating a component of the user device to allow the transaction to proceed. The step of initiating the process may include activating the communicator of the user device to allow the transaction to proceed.

In some embodiments, the step of initiating the process includes one or more of triggering the process during the transaction, initiating a decryption process for the transaction, providing information from the movement sensor to the communicator for communication to the reader device, storing information from the movement sensor, and comparing information from the movement sensor with stored movement information.

In one embodiment, the step of initiating the process includes using stored information to change the nature of the transaction in progress. For example, the account being used for the transaction may be changed.

In a fourth aspect, a reader device for use in a transaction with a user device according to the above described first aspect is provided.

In a fifth aspect, a reader device for use in a system for executing a transaction according to the above described second aspect is provided.

In sixth aspect, a reader device for use in a transaction is provided. The reader device includes a communicator configured to allow communication, between a user device and the reader device, for executing the transaction, a sensor for detecting a movement of the user device, and a trigger element configured to, on detection of the movement of the user device, initiate a process for the transaction.

Further aspects include computer programs (or a media device storing such a program) which, when loaded into or run on a computer, cause the computer to become devices or systems, or to carry out methods, according to the aspects described above.

The above aspects and embodiments may be combined to provide further aspects and embodiments.

### BRIEF DESCRIPTION OF THE DRAWINGS

The disclosure will now be described by way of example with reference to the accompanying drawings, in which:

FIG. 1 is a diagram illustrating a basic proximity transaction system;

FIG. 2 is a diagram illustrating a transaction card according to an example embodiment of the present disclosure;

FIG. 3 is a diagram illustrating a mobile device according to an example embodiment of the present disclosure;

FIG. 4 is a diagram illustrating examples of steps in a method according to an example embodiment of the present disclosure; and

FIGS. 5-7 are diagrams illustrating options for secure modules according to example embodiments of the present disclosure.

### DETAILED DESCRIPTION OF THE DISCLOSURE

In description of the example embodiments herein, “proximity transaction” may mean any near-field, close-range, contactless or wireless transaction undertaken with a device in the vicinity of a terminal or reader, such as those for devices compliant with ISO/IEC 14443 Standard, ISO/IEC 18000 standard, or the NFC standards including ISO/IEC 18092/ECMA 340 and ISO/IEC 21481/ECMA 352. A device for such transactions may be further compliant with both the ISO/IEC 14443 Standard and the “PayPass” standards promulgated by MasterCard International Incorporated. Other contactless devices, such as mobile telecommunication devices enabled with contactless or NFC technology, may also benefit from embodiments described herein, particularly where the contactless device is of a type that is activated when a radio frequency chip on the device is activated by a magnetic field.

The embodiments described herein provide elements of a system for detecting or registering movement of a user's transaction device, and using the detection of the movement to enable, supplement, inform or manage a transaction, or future transaction, in some way. For example, the detection can trigger the activation or deactivation of some component of the user device or system. The movement is captured by a movement or motion sensor incorporated in the user device, or in a reader transaction device which senses the movement of the user device. A movement alone can provide the trigger, or a movement corresponding to a prescribed or stored movement.

Once such a movement detection system is in place, the output can be applied in many facets of common transactions, as an additional function in any transaction system. Thus it can be used to supplement or replace many current transactional actions, such as authentication of a user, anti-fraud measures, or changing of an identity feature or account of a user and the like.

It is also an unconventional function in such transaction systems, different from other known transactional features (such as entering a PIN, inserting smart card chip contacts into a corresponding reader, entering a password, interacting a contactless device with a reader) and may therefore be useful as a supplement in such transactions to enable different types of interaction with transactional devices.

The movement detected or matched (with a prescribed movement) is also potentially highly complex and personalized, and may therefore be particularly useful to address security or privacy concerns. For example, unintentional or unauthorized use may be prevented until the required movement is detected.

The use of a movement sensor means the trigger system is simple, and may therefore be more reliable and accessible or interactive than, for example, a manual switch incorporated into a transaction card.

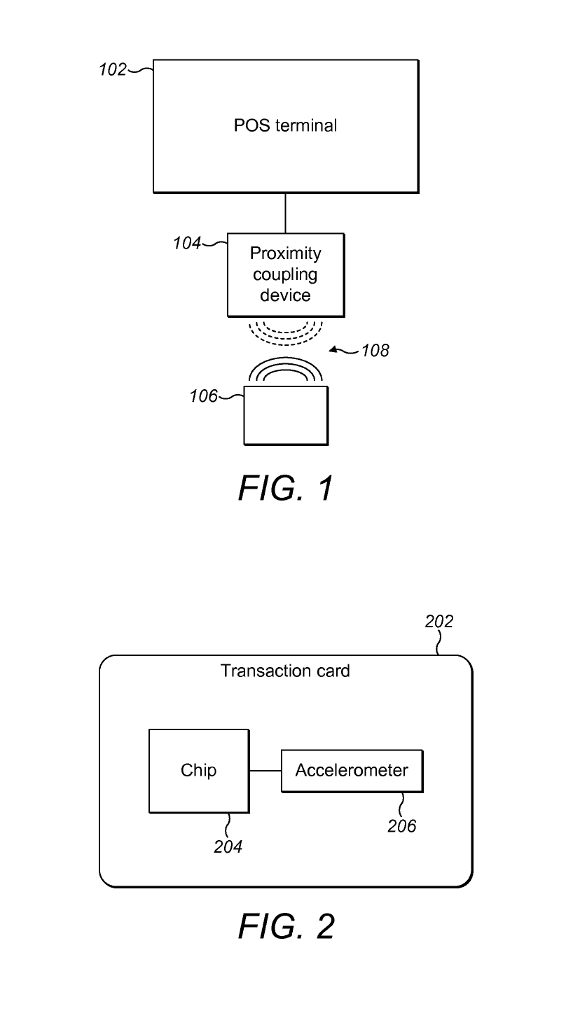

FIG. 1 is a diagram illustrating a basic proximity transaction system. The user device 106, once near enough to the proximity coupling device or reader 104, can interact (108) with the reader using any known local interaction method, such as an electromagnetic field generated by the reader interacting with a receiver on the user device. The reader is connected to, in this example, a point-of-sale terminal (102)—this terminal could of course be any hosting terminal using the reader, such as a unit for processing ID details on the user device.

The devices, systems and methods described herein are particularly effective for proximity or near-field transactions, but are equally applicable to other types of transaction, such as chip and PIN transactions using EMV chips or the like, magnetic stripe interactions and interactions (proximity or otherwise) using mobile devices, such as mobile-enabled near-field transactions, peer-to-peer wireless transactions, and the like. This is because the detection of motion of the user device can have many different applications with respect to the transaction, as noted herein. For example, for a chip and PIN card interaction, the motion detection may activate or deactivate the transaction card or the chip itself, or provide additional verification of the user's identity. For a mobile device transaction, the motion detection can be used to collect motion information, which can be sent alongside the normal transaction, as anti-fraud information.

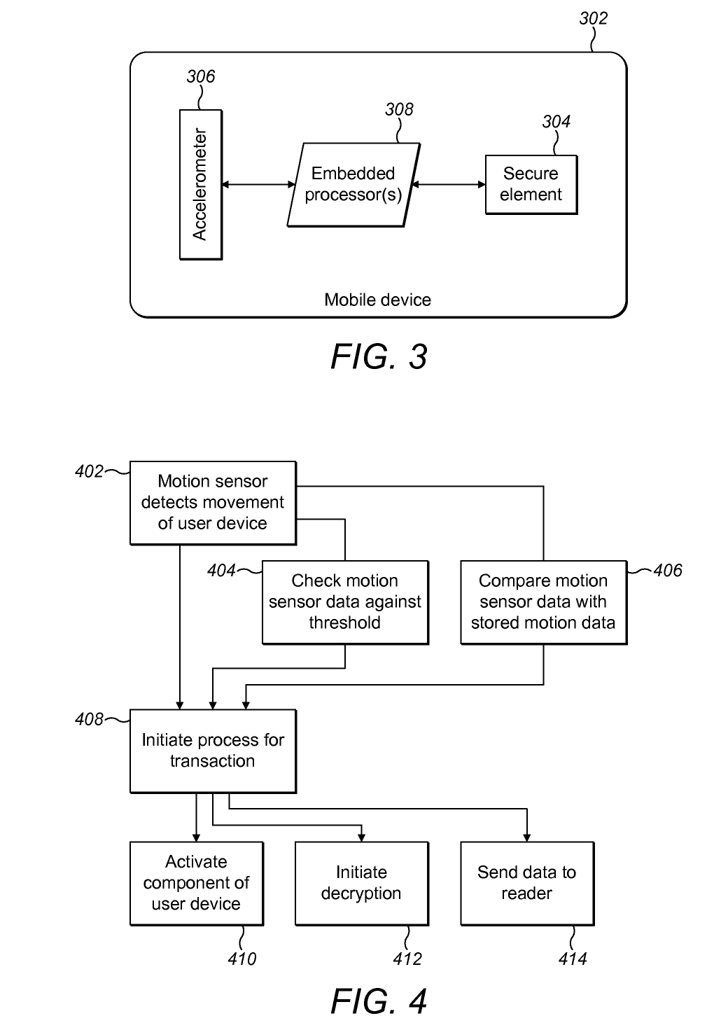

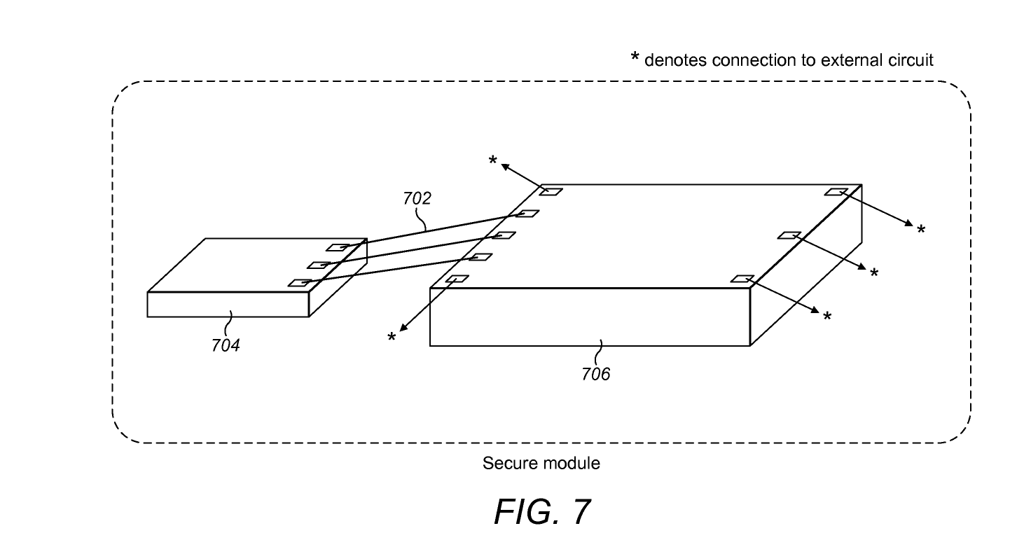

One example of a device usable in a proximity transaction as illustrated in FIG. 1 is a transaction card, as shown in FIG. 2. The transaction card (202) in this example is a smart card, incorporating a chip 204 such as an EMV chip, in the known way, for example in a sandwich of laminated layers. In addition however, the card has an on-board accelerometer (206), which can be used to detect movement or motion of the card. The accelerometer may be separate from the chip, or the two may be added in a combined chip, in similar fashion to options for a mobile device chip, as described below with reference to FIGS. 5 to 7. The separate accelerometer may also be additional to an accelerometer incorporated in a combined chip.

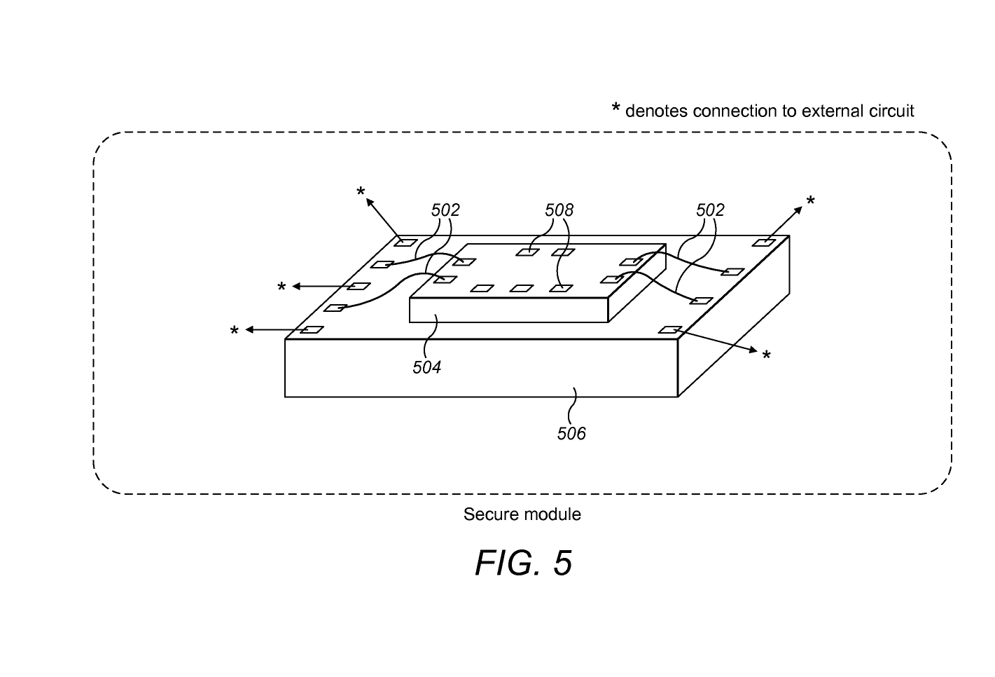

Another example of a device for such transactions is a mobile device as shown in FIG. 3. The mobile device (302) may be for example a smartphone, enabled for near-field communication (NFC) or for identification applications. The mobile device contains a typical secure element (304) such as a SIM card, which may contain credentials for use in identification or payment applications. The mobile device additionally incorporates an accelerometer (306), which can be used in the ways described herein for transactional applications, such as payment or identification. The accelerometer may be separate from the secure element, and/or incorporated in the secure element, for example as described below with reference to FIGS. 5 to 7. As is common in such devices, the mobile device includes one or more embedded processors (308) which may take part in transactions, making use of information from the accelerometer(s).

Other embodiments may be used to selectively control activation of devices containing various types of data, such as contactless driver's licenses, contactless passports, medical information cards, training cards, or the like. Such devices may be used for payment transactions (such as PayPass payment devices) or used for storage of personal information (such as driver's licenses, passports, or the like).

The accelerometer(s) in the devices shown in FIGS. 2 and 3 may be of the common microelectromechanical (MEMS) type, having two variable capacitors formed by an arm or plate moveable between two fixed arms. Movement of the user device causes movement (due to its inertia) of the moveable plate, the amount of movement (velocity and/or acceleration) being measurable by the formed capacitors. One such arrangement in each of three orthogonal directions can give all three dimensions of movement, and assess different types of movement such as roll, pitch and yaw, rotation, and the like. The accelerometer(s) may alternatively be of the hot gas chamber-type known to the art.

The chip incorporated into the transaction card (202) can be of any of the known types, for example an integrated circuit bonded to a substrate mounted on the card. In a contactless or proximity transaction system, the chip can be powered, for example by RF induction, using an antenna/inductor incorporated into the card, for example as in an RFID system. The signal received from, for example, a reader device can thus power and interrogate the chip, and information from the chip can be transmitted back to the reader, via the antenna. Processing of movement data from the accelerometer can be undertaken on the chip, or on an additional processor.

The mobile device of FIG. 3 can be any of the known types which provide at least a chip usable as a data store, a processor, and an accelerometer or similar motion sensor. Such devices typically contain transceivers and antennae, but may also be enabled with NFC or similar technology, using a similar RF induction antenna as in the transaction card described above.

The motion sensor incorporated in the user device or reader may, instead of an accelerometer, take other forms. For example, a miniature microphone, or acoustic vector sensor, may be used to pick up movement of the user device, by measuring sound waves or air particle movement relative to the device. In certain circumstances, for example in indoor applications, a high resolution GPS system may be used to assess movement of the device. A sensor on the reader device rather than the user device, may measure motion of the device by any common motion sensing method, for example using a light or reflective sensor, or an electromagnetic field interacting with the user device.

The chip(s) and/or processor(s) of the devices, such as those illustrated in FIGS. 2 and 3, can be loaded with software in order to undertake the various functions described herein, such as recording motion sensor data, storing the data, comparing stored data against instant measured motion data, and the like.

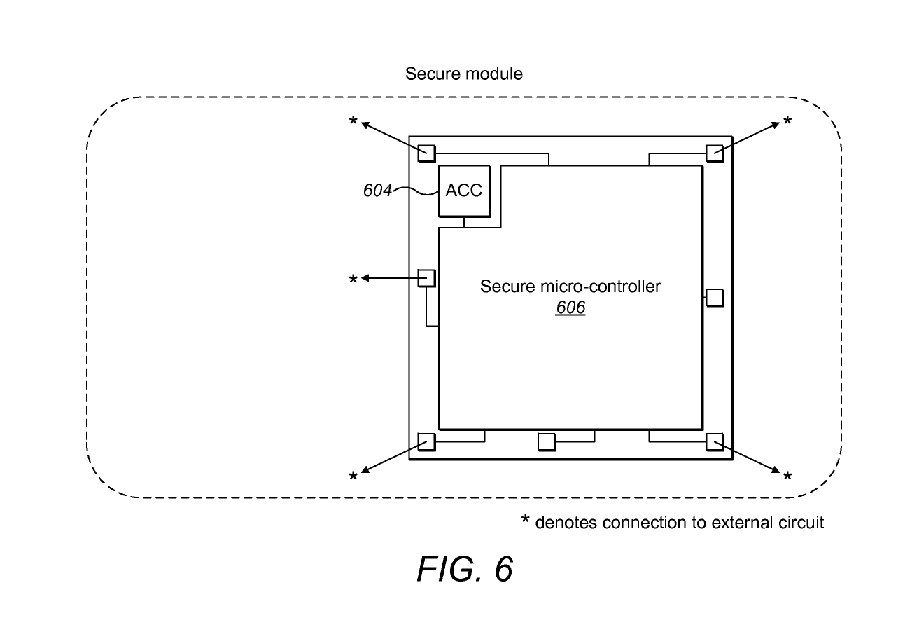

FIG. 4 illustrates a series of steps used in example embodiments of a method using the devices and systems described herein.

In these embodiments, initially a motion sensor detects movement of the user device (402). Some of the possible alternatives for the next step in the method are then illustrated. The motion sensor itself may directly trigger the initiation of the process for the transaction (408); for example if the movement to be detected is a simple acceleration in one direction, perhaps sufficient to move a suitably damped accelerometer (such as a hard tap on the device), this may trigger the process initiation. Alternatively, a processor of the user device may check that the movement detected exceeds a specified threshold (404), and if so initiate the process. In another example embodiment, the motion sensor data is compared by the processor with stored motion data (406), for example to establish whether a particular prescribed motion of the user device has been detected.

These or other actions trigger the initiation of the process for the transaction (408). FIG. 4 sets out certain of the possibilities for the process; for example, the detection of the movement may trigger activation of a component of the user device (410), for example switching the device on, or switching on all components except the motion sensor which may remain active indefinitely. The movement may trigger a decryption process (412); for example the detection of movement may be used by the processor to unlock or decrypt a secure portion of a chip in the user device, the portion storing personal or account data for the user to be protected, but necessary for use in the transaction. The movement may trigger sending data to the reader (414); for example, the user device may already be activated and in the process of undertaking a transaction, but the transfer of data from the user device to the reader may be prevented until a prescribed user movement has been detected.

One option for the process of activating a component of the device, may be to turn on a power source for a component. Another may be to switch power, already established, to that component. In one example embodiment, the activation step enables the means for communication incorporated into the device. For example, the trigger may enable or power-on an antenna or transceiver on the device. Alternatively, the trigger may enable the transceiver to receive power being received by the antenna, for example if the device is already in range of an NFC field.

For these and similar processes available, the process can be reversed in order to lock (again) or de-activate the relevant component(s). For example, the same prescribed movement if detected again, or a second prescribed movement, could simply reverse the process, for example turning off an antenna or chip.

In another example, the movement(s) may be used to activate/deactivate an EMV chip in a chip and pin environment, or enable/restrict the cryptographic function of the chip.

The ability to turn the device, or components of it, on and off provides clear security and privacy advantages for the device. For example, since the device is no longer “always on”, there are fewer opportunities for eavesdropping-type attacks, and if the device is stolen, it will be more difficult to use it fraudulently. The device may be activated, ready for a transaction, and/or deactivated, before or after, rather than during a transaction. For example, the movement may be used to deactivate a device that has been left active, or in a transaction-ready state, in order to prevent fraudulent use or interception.

An additional advantage of the ability to turn the device on and off using the movement detected, is that reliability of the device may be improved in contrast to a device in which the communication means is “always on”. The device is also more responsive to the user's needs, in contrast to such prior devices.

In some embodiments, the movement detection may trigger a process during a transaction already underway. For example, a mid-transaction decryption process may be started, as described above.

The sensor may be of any of the types described above, the input to the sensor may be any type of movement of the user device, such as translation or rotation, and the sensor may detect any type of motion, such as velocity, acceleration, angular momentum and the like. The sensor may be incorporated into the user device, as shown in FIGS. 2 and 3, or alternatively may be in or on a reader or proximity coupling device. The motion detected may therefore be of the user device relative to itself (for example, detecting movement relative to acceleration due to gravity) or relative to an object, such as the reader device.

The movement detected or detectable may take many different forms. The movement may be a positive action, movement or gesture by the user to move the device in a certain way, for example to match a prescribed movement for a given process. For example, a hard tap, or prescribed number of back-and-forth “shakes” of the user device, or moving the device in a figure-of-eight motion might be the prescribed motion. In general, the more complex the movement, as long as it may be recognized by the sensor (and if necessary, a processor), the more secure the feature the movement detection is used for, as the movement will be more difficult for a fraudulent user to replicate.

Alternatively, the movement may be automatically recognized by the device, by comparison of a detected motion with stored motion information. For example, the device may store motion information continuously, or at times of transactions being performed, and build a composite of the stored motion information so that this composite prescribed motion can be matched to a given detected motion. If a motion matching the composite closely enough occurs, for example the user makes the usual motions associated with a transaction, such as removing the device from a pocket or handbag in the user's particular manner, before moving it towards a reader, the device may then initiate the transaction process, for example enabling or activating the device. Other motions of the device, such as normal movement in the pocket or handbag, would not trigger the process initiation.

One advantage of the automatic recognition of movement is that the functionality can be built-in to devices without having to educate users as to how to imprint a prescribed movement on the device.

The movement detected and means for actuating the transaction process (such as activating the device) may be as simple as a single movement of the device (such as a hard tap on the device) triggering a mechanical sensor on the device, which actuates the process. Such a detection would not therefore require a prescribed or programmed movement to be matched; the movement itself would be sufficient to be the trigger. For example, the device may have a mechanical MEMS accelerometer such as those of the type described above, suitably damped so that a hard tap is distinguishable from normal movement of the device, for example in the pocket of the user. The accelerometer may mechanically trigger a latch or switch to activate or de-activate the device, or power a component. This has the advantage that no part of the user device needs to be powered for the movement to be detected.

The means of actuation may be a simple electronic activation. For example, an accelerometer may have a similar design, but the accelerometer may electrically activate a switch. The device of this embodiment may then automatically close the switch electronically when, for example, the device leaves the NFC interaction volume and no NFC is being received to power the device.

In some embodiments, the motion detected may produce motion data which is sent to a processor of the device, to determine an action. The processor may determine any of the actions described above, such as activating the device. The processor may analyze the motion data in the ways described, for example to match a detected movement with a learned movement for the user. The processor will typically be loaded with one or a set of software algorithms to achieve these tasks.

Various options are available for the data sent (414) from the device to the reader, proximity detector or terminal For example, authentication information for the transaction could be sent, such as secured personal or transaction data from a secure element on the device, unlocked by the detected motion.

The device may also send details of the movement or motion detected to the reader. This may be useful for anti-fraud measures; for example there may be a prescribed movement to alert a transaction provider that the transaction is being performed under duress. The user may use the gesture, unknown to a third party, and the transaction may be processed as usual at the terminal, but because the “duress” movement data has been received, the transaction may be invalidated by the provider, or later annulled.

This feature may also be useful for practicality or reliability of the system. For example, if the user uses a gesture which approximates the prescribed motion but does not match it, the terminal may refer the motion data to a transaction provider to check whether the transaction can be passed in spite of the unclear match. In another example embodiment, the motion data may always be transferred to the reader during any transaction; this would allow the local system, backed by the provider, to assume that the correct gesture had been used even in cases where the match likelihood was low, but to check or block the transaction in cases where the amount of the transaction was high, in addition to a low match probability for the movement. This may make the system more robust, so that users are not needlessly prevented from completing transactions if the movement is not quite exact, or if the sensor is malfunctioning.

The movement or motion detection is not limited to a single movement of the user. For example, if the normal activation motion is used to activate the device, a different motion, such as a hard tap, can be used for a further similar or different function, for example to change a user account to be accessed or used, or to reset the device, or as an emergency de-activation instruction.

The means for communication between the device and the terminal or reader may be any of those noted above, or any of a number of alternatives which are sufficient to be able to transfer information from the user device to the reader. For example, the process triggered by the detected movement may enable display of a barcode or similar on the user device (for example, a mobile device with a display), for reading by a barcode scanner on the reader. Alternatively, the process triggered may be to encrypt the personal or user information for reproduction in data to be read, the reader having the corresponding key of a public-private pair. In the case of a smart card having a chip, in a chip and PIN system, the means of communication are the contacts on the smart card, connected to the chip, which contact the corresponding terminals on the reader when the card is inserted.

In an alternative embodiment, the reader or proximity coupling device may house the sensor, instead of the user device. The sensor used will be more limited, but it will still only be necessary to measure movement of the user device. Any known light sensor, electromagnetic field, or other arrangement may be sufficient for this purpose. Alternatively, the reader may contain an accelerometer of its own, to measure movement of a contact surface on the reader; here the prescribed movement might be a particular type or number of physical taps on the contact surface, which the accelerometer on the reader would pick up.

In one example embodiment a user device, once brought within range of an NFC field can be recognized by the reader to initialize a transaction. The reader contains a processor monitoring the NFC field for changes, so that movement of the user device can be tracked. A prescribed movement of the device can therefore be measured, and once obtained, the transaction can be enabled, for example by activating a component of the user device, or by enabling receipt of data from the user device by the reader.

In some embodiments, the user device or the reader has an indicator to alert the user either to the device or system having recognized or picked up the movement, or to confirm that the intended process is underway. The indicator may be visual, for example an LED on the reader or device, or use other sense types, such as an auditory alert using a speaker. This allows the user to know that the movement recognition has worked, and they can proceed. This can be used to complement the feature noted above in which the transaction can be undertaken in any case if the movement is not quite matched, making the system still more robust.

As noted above, an identification transaction may benefit similarly from the embodiments described herein. Here, the data in the device to be read by the terminal or reader will be personal identification data. The transfer of this data is undertaken by any similar means, for example by contactless transfer between the user device, such as a chipped ID card, and the reader. The movement detection, by sensor on the device or reader, again provides a trigger for some process affecting the transaction, for example decrypting or enabling a secure element to allow the data transfer. The options discussed above are similarly available here; for example in an embodiment the transfer of movement data from device to reader is always made during a transaction, which means that a reader could detect an unauthorized movement and alert security, unbeknownst to a fraudulent user attempting to gain access. The use of a prescribed movement to change a transaction feature may be used to change an identification feature to be used.

FIGS. 5 to 7 illustrate options for secure modules according to example embodiments. The secure module or element may be a SIM or EMV card or the like. In some embodiments, the user device may be one having an on-board micro-controller, to which an accelerometer or other sensor may be connected, or to which the sensor may be bonded to provide a combined chip. Such a device may be a transaction card having a microprocessor, or a mobile device usually having such components.

An advantage of the sensor and chip being sited or combined in the same module is that the module as a whole can be secured, for example by a keyed or encrypted security protocol, so that the accelerometer is also part of the secure environment on which the user's transaction or personal data is stored and/or processed.

This may be important in preventing spoofing of the accelerometer signal by malware or a trivial modification of the device or apparatus (such as a reader) involved in the transaction. If the accelerometer is otherwise connected to the secure element (rather than incorporated in it) via an interface that is under the control of application software, then it may be possible for code to be introduced either intentionally or maliciously to modify or impersonate the prescribed motion, possibly permitting data to be transmitted or used when it should not be. The implementation of the interaction between the sensor and the chip or processor may vary across platforms, and for example in the future some mobile devices for example could have “trusted” or otherwise secured connections between some of their components, such as keyboard and screen, rendering them unavailable to an attacker.

The secure module for such devices may be constructed as in FIG. 5, with an accelerometer chip (504) bonded to the secure die. The accelerometer chip (504) is mounted on the microcontroller (506), and may be connected to the microcontroller by chip-to-chip bond wires (502) and/or by through-silicon vias (508). In FIGS. 5 to 7, the microcontroller has connections to other components of the device not illustrated; these connections are denoted by asterisks (*) in the Figures.

FIG. 6 illustrates an alternative embodiment in which the accelerometer is integrated on the secure die. The microcontroller (606) and accelerometer chip (604) are mounted on the same substrate. This may have the advantage of providing a more compact module for incorporation into the user transaction device.

FIG. 7 illustrates another alternative embodiment in which the accelerometer is wired to the secure die. The microcontroller (706) is simply connected to the accelerometer chip (704) by chip-to-chip bond wires (702).

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor, and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A user device for use in a transaction, the user device comprising:
a communicator configured to allow communication, between the user device and a reader device, for executing the transaction;
a sensor configured to detect a movement of the user device; and
a trigger element configured to, on detection of the movement of the user device, initiate a process for the transaction.

2. A user device according to claim 1, wherein the transaction is a proximity transaction.

3. A user device according to claim 1, wherein the trigger element is configured to, on the detection of the movement, activate a component of the user device to allow the transaction to proceed.

4. A user device according to claim 3, wherein the trigger element is configured to, on the detection of the movement, activate the communicator to allow the transaction to proceed.

5. A user device according to claim 1, wherein the trigger element is configured to, on the detection of the movement, trigger the process during the transaction.

6. A user device according to claim 1, wherein the trigger element is a processor, and wherein the processor is configured to, on the detection of the movement, perform at least one of initiating a decryption process for the transaction, providing information from the movement sensor to the communicator for communication to the reader device, storing information from the movement sensor, and comparing information from the movement sensor with stored movement information.

7. A user device according to claim 1, wherein the trigger element is configured to initiate the process on detection of a prescribed movement of the user device.

8. A user device according to claim 1, wherein the sensor is an accelerometer, and wherein the trigger element is mechanical.

9. A user device according to claim 1, wherein the user device is one of a transaction card comprising an integrated circuit chip and a mobile telecommunication device.

10. A user device according to claim 1, the user device further comprising an indicator, the indicator configured to be activated on one or both of:
the detection of the movement by the sensor; and
the initiation of the process for the transaction.

11. A system for executing a transaction, comprising:
a user device;
a reader device, wherein each of the user device and the reader device comprises a communicator configured to allow communication, between the user device and a reader device, for executing the transaction;
a sensor configured to detect a movement of the user device; and
a trigger element configured to, on detection of the movement of the user device, initiate a process for the transaction.

12. A system according to claim 11, wherein one of the user device and the reader device comprises the sensor.

13. A system according to claim 11, further comprising an indicator, the indicator configured to be activated on one or both of:
the detection of the movement by the sensor; and
the initiation of the process for the transaction.

14. A method of initiating, for a user device, a process for a transaction, the user device including a communicator configured to allow communication, between the user device and a reader device, for executing the transaction, the method comprising:
detecting, by the user device, a movement of the user device; and
on detection of the movement of the user device, initiating a process for the transaction.

15. A method according to claim 14, wherein detecting a movement comprises detecting a prescribed movement of the user device, and wherein initiating a process comprises initiating the process on detection of the prescribed movement.

16. A method according to claim 14, wherein the transaction is a proximity transaction.

17. A method according to claim 14, wherein initiating a process comprises activating a component of the user device to allow the transaction to proceed.

18. A method according to claim 17, wherein initiating a process comprises activating the communicator of the user device to allow the transaction to proceed.

19. A method according to claim 14, wherein initiating a process comprises triggering the process during the transaction.

20. A method according to claim 14, wherein the initiating a process comprises at least one of initiating a decryption process for the transaction, providing information from the movement sensor to the communicator for communication to the reader device, storing information from the movement sensor, comparing information from the movement sensor with stored movement information, and using stored information to change the nature of the transaction in progress.

21. A media device storing computer program code adapted, when loaded into or run on a computer, to cause the computer to carry out a method according to claim 14.
